(19) United States
(12) Patent Application Publication
(10) Pub. No.: US 2005/0030870 A1
(43) Pub. Date: Feb. 10, 2005

(54) Method and device for recording marks in recording layer of an optical storage medium

(76) Inventors: Johannes Cornelis Norbertus Rijpers, Eindhoven (NL); Bernardus Antonius Johannus Jacobs, Eindhoven (NL)

Correspondence Address: Corporate Patent Counsel;Philips Electronics North America Corporation, PO Box 3001, Briarcliff Manor, NY, 10510, US

(21) Appl. No.: 10/496,551

(22) PCT Filed: Nov. 25, 2002
(86) PCT No.: PCT/IB02/05041

(30) Foreign Application Priority Data
Nov. 28, 2001 (EP) 01204579.5
Jun. 12, 2002 (EP) 02077312.3

(51) Int. Cl. G11B 5/09

(52) U.S. Cl. 369/59.11; 369/59.12

(57) ABSTRACT

The invention relates to a method and to a recording device for recording marks (1) in a phase-change type storage medium. Generally, an nT mark (1) is recorded by a sequence of n−1 or less write pulses. In slow cooling stacks, this results in low quality marks. The invention proposes to increase the cooling period in between the multi-pulses (3) in a sequence of write pulses by applying multi-pulses (3) with a pulse duration of Tₘₚ<4 ns and duty cycle of Tₘₚ/T_{w} where T_{w} is the reference clock period time and T_{w}<40 ns. In this way very good quality marks (1) are obtained even after a large number of direct overwrite (DOW) cycles and at a wide recording power and recording velocity window.

The invention relates to method of recording marks having a time length of n*T_{w}, n representing an integer larger than 1 and T_{w} representing the length of one period of a reference clock, in a storage medium, said storage medium comprising a recording layer having a phase reversible material changeable between a crystalline phase and an amorphous phase, by irradiating the recording layer with a pulsed radiation beam, each mark being written by a sequence of pulses comprising a first pulse followed by m multi-pulses, m representing an integer larger than or equal to 1 and lower than or equal to n−1.

The invention also relates to a recording device for recording marks in an optical storage medium, said storage medium comprising an recording layer having a phase reversible material changeable between a crystal phase and an amorphous phase, capable of carrying out the above method.

A recording layer having a phase reversible material changeable between a crystalline phase and an amorphous phase is generally known as a phase-change layer. A recording operation of optical signals is performed in such a manner that the recording material in this layer is changed in phase reversibly between an amorphous phase and a crystalline phase by changing the irradiation conditions of a radiation beam thereby to record the signals in the phase-change layer, while a playback operation of the recorded signals is performed by detecting differences in optical properties between the amorphous and crystalline phases of the phase-change layer thereby to produce the recorded signals. Such a phase-change layer allows information to be recorded and erased by modulating the power of the radiation beam between a write power level and an erase power level.

A method according to the preamble for recording information in a phase-change layer of an optical storage medium is known for example from U.S. Pat. No. US 5,732,062. Here a nT mark is recorded by a sequence of n−1 write pulses with a duty cycle substantially close to 50%. The previously recorded marks between the marks being recorded are erased by applying an erase power in between the sequences thus allowing this method to be used in a direct-overwrite (DOW) mode, i.e. recording information to be recorded in the recording layer of the storage medium and at the same time erasing information previously recorded in the recording layer. To compensate for heat accumulated during recording of a previous respectively a following mark being recorded the write power level of the first respectively the last write pulse in the sequence of pulses is higher than that of the remaining write pulses in that sequence. The heat accumulation causes distortion of the recorded marks. These marks have, for example, a reduced mark length. Furthermore, it is often observed that these marks result in a reduced modulation of the reproduced recorded signals during playback. The modulation is the difference of the amplitude of the signal resulting from an area on the recording layer having a mark and the amplitude of the signal resulting from an area on the recording layer having no mark. Generally a phase-change optical storage medium has a recording stack including a metal reflective layer proximate the recording layer. Leaving out the metal reflective layer from the stack not only has consequences for the optical behavior of the recording layer, but apparently also for its thermal characteristics. The metal has a much higher heat conductivity than the interference layers and the phase-change layer. This heat conductivity of the metal reflective layer appears to be advantageous for the actual writing process of amorphous marks. During the writing process the phase-change material is heated to above its melting point by the write pulse. Subsequently, the phase-change material is cooled rapidly to prevent re-crystallization of the molten (i.e., amorphous) material. For this process to be successful, it is necessary that the cooling time is shorter than the re-crystallization time. The large heat conductivity and heat capacity of the metal reflective layer help to remove the heat quickly from the molten phase-change material. However, in a (semi-) transparent recording layer without, or with a reduced amount of, such a cooling metal reflective layer, the cooling time seems to become longer giving the phase-change material time to re-crystallize. This results in marks of low quality.

In non-prepublished European Patent application 01201531.9 (PHNL010294), filed by Applicants, a method according to the preamble for recording information in a phase-change layer of an optical storage medium is described using, e.g., an n/α pulse strategy, with α=2 or 3, in which method the number of write pulses for writing an nT mark is set to the nearest integer larger than or equal to n/α. This method allows for a longer cooling period in between two succeeding write pulses in a sequence of write pulses because less pulses are used at a larger distance. This increased cooling period may result in marks having a better quality than when using, e.g., an n−1 strategy. In such a strategy, when α is set to 3, 4T, 5T and 6T marks are all recorded by a sequence of 2 write pulses. Because of this, an additional fine tuning of the write pulses is required. These adjustments may be performed by adjustments of pulse power, pulse duration and pulse position. In most cases the adjustments are different for each mark length and each recording velocity which is troublesome to implement. Thus, this strategy is sensitive to power fluctuations of the radiation beam and has a relatively difficult mark length control.

It is an object of the invention to provide a method of recording marks of the kind described in the opening paragraph which method results in recorded marks of good quality (i.e. correct mark position, mark length and mark width), which is easy to implement, which has a wide power margin, e.g. 0.9-1.25 times the optimal recording power, and which method results in recorded marks that remain of good and constant quality during a large number of direct-overwrite (DOW) cycles, e.g. 1000 or more, and at a wide recording velocity range, e.g. between about 3.5 m/s and 14 m/s.

This object is achieved when the method of the preamble is characterized in that the multi-pulses have a pulse duration Tₘₚ<4 ns, while T_{w}<40 ns and that the first pulse has a pulse duration T_{first}≧Tₘₚ.

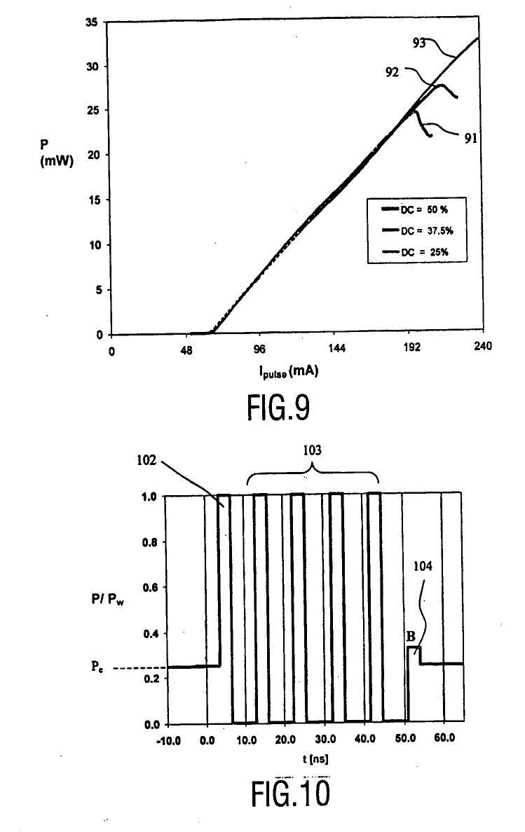

It was observed that when shortening the pulse durations of the multi-pulses the mark formation quality is substantially constant over a large number of DOW cycles. The shorter pulses require higher power levels from the radiation beam, e.g. a semiconductor laser, which is feasible because the duty cycle of the laser is reduced allowing higher power level without the danger of laser saturation. For a conventional write strategy the average duty cycle for the laser is 50% or close to this value. At this duty cycle the maximum available laser power is about 21 mW, when corrected for a lifetime margin of about 10% (see FIG. 9 curve 91). When using short pulses, i.e. a low duty cycle, the lower thermal load of the laser causes the maximum available laser power to be higher, e.g. 30 mW (see FIG. 9 curve 93).

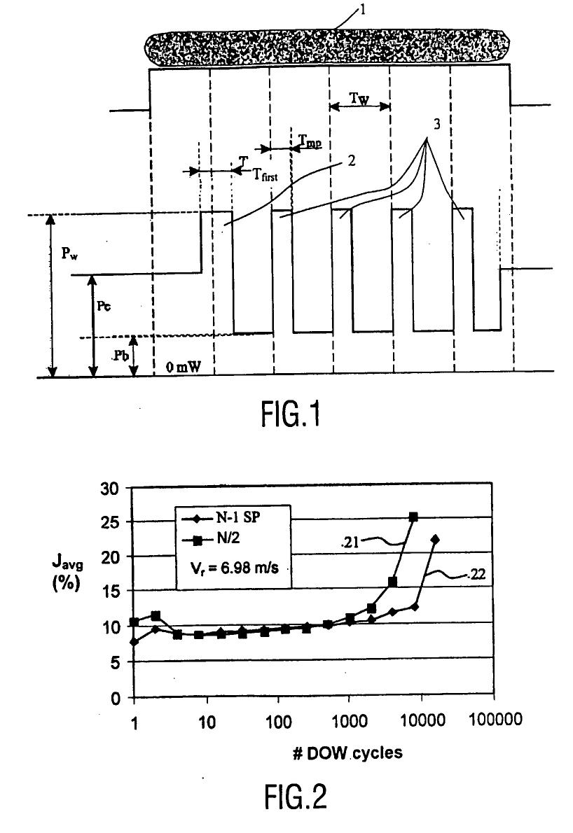

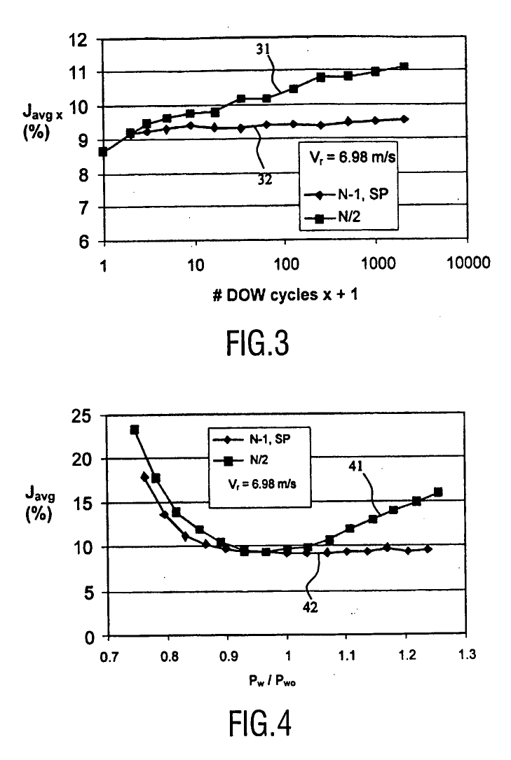

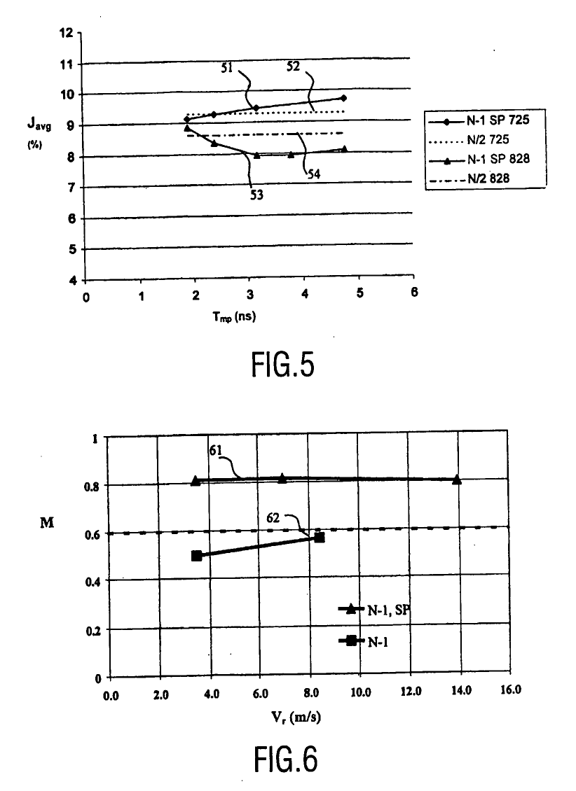

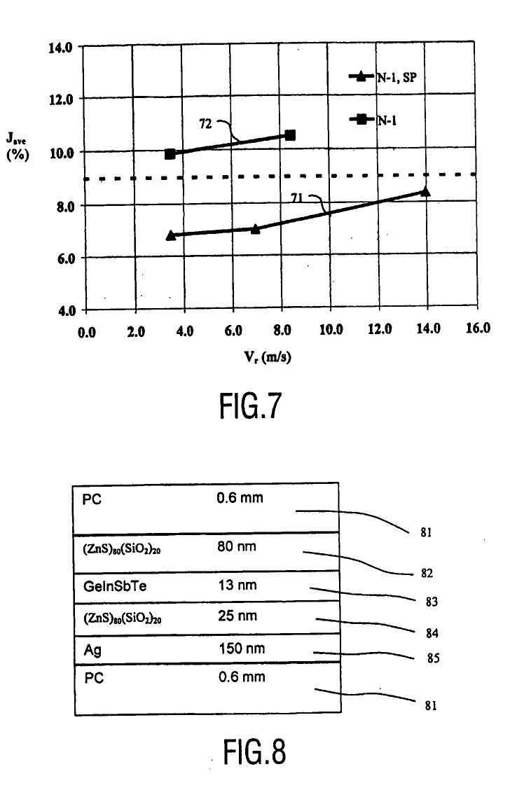

Besides the intended effect of longer spaces the short pulse write strategy has the following advantages:
Lower thermal load of the laser and a longer lifetime potential (FIG. 9).
Lower thermal load of the disk upon writing resulting in a longer lifetime (more DOW cycles) and less thermal cross talk between adjacent tracks (FIG. 2 and FIG. 3).
A wider write power window (FIG. 4).
Low jitter (FIGS. 5 and 7) and higher modulation of marks during read-out.
A wide recording velocity window (FIG. 6).

Note that the first pulse generally has a pulse duration larger than Tₘₚ which is advantageous in order to compensate for thermal effects e.g. the first pulse does not or hardly “feel” the influence of previous pulses in previous marks whereas the multi-pulses “feel” the influence of the first pulse.

In an embodiment T_{first}=Tₘₚ. In this case broadening of the first pulse is not required e.g. due to certain material properties of the recording layer. The advantage is that all pulses have the same pulse duration which is more easy to implement.

In further embodiments Tₘₚ/T_{w}<0.30, Tₘₚ/T_{w}<0.15 or Tₘₚ/T_{w}<0.075. Depending on the linear recording velocity of marks in the optical storage medium the value of Tₘₚ/T_{w} may vary. For instance, when the linear recording velocity of the laser is 13.96 m/s (DVD 4-speed) at a reference clock of 9.55 ns and a pulse duration of 2.7 ns the ratio Tmp/Tw is equal to 0.283. The length of one period of the reference clock usually is set inversely proportional to the linear recording velocity, in order to keep the mark length constant. Basically, the minimum pulse duration is limited by the driver electronics of the laser in combination with the maximum physical output of the laser itself. At a lower linear recording speed, e.g. 3.49 m/s (1-speed), the value of Tₘₚ/T_{w} at a pulse duration of 2.7 ns is equal to 0.0707. For the embodiment as described in FIGS. 2 and 3, having a linear recording speed of 6.98 n/s (DVD 2-speed), it can be noted that the mark formation quality remains good and constant until up to more than 1,000 DOW cycles. In future recording systems the pulse duration and duty cycle may be shortened even more when very high power semiconductor lasers become commercially available and are economically feasible.

In a favorable embodiment the number of multi-pulses m has the value n−2. This has the advantage that in total n−1 pulses are written which corresponds to an n−1 strategy. This strategy is known to be robust especially when changing the recording speed. The n−1 strategy remains possible at higher recording speeds. The maximum speed is limited by the amount of laser power available in the pulse and thus the capacity of the laser and of course by the mechanical limitations of the medium and the drive.

In further embodiments the power of at least one pulse in the sequence of pulses is set in dependence of T_{w} or the duration of at least one pulse in the sequence of pulses is set in dependence of T_{w}. Occasionally it may be required to adjust or fine tune one or more of the pulses for writing a recorded mark properly. This may be required because of limitations of the structure of the recording stack, recording material, limitations in the laser driver electronics and/or limitations in the laser itself.

In a special embodiment the multi-pulses have a pulse height P_{w}, and an additional pulse is present which has a pulse height smaller than P_{w} but higher than Pₑ, and Pₑ being a constant erase level of the radiation beam. This has the advantage that this additional pulse controls the amount of backgrowth of the crystalline environment surrounding the amorphous mark. Backgrowth is recrystallization from the edge of an amorphous mark when the temperature of the recording layer material is relatively elevated but well below its melting point. As an example, in FIG. 10, at the end of the sequence of pulses there is an extra pulse B for controlling back growth of the crystalline structure.

It is noted that the method according to the invention can advantageously be used in any high speed optical recording system using a storage medium comprising a single recording layer or multiple recording layers of the phase-change type were the cooling time becomes critical. In these systems the cooling time during recording becomes shorter due to the rapid sequence of write pulses. The method according to the invention allows for a longer cooling period.

It is a further object of the invention to provide a recording device for carrying out the method according to the invention.

This further object is achieved when the recording device of the preamble is characterized in that the recording device comprises means for carrying out anyone of the methods according to the invention.

These and other objects, features and advantages of the invention will be apparent from the following more particular description of experimental results and an embodiment of the invention, as illustrated in the accompanying drawings where

FIG. 1 shows a mark and a sequence of pulses representing a write strategy for writing the mark for e.g. DVD+RW and CD-RW with the definition of the different power levels and time durations.

FIG. 2 shows two graphs representing the average jitter J_{avg} (in %) as a function of the number of DOW cycles for both a method according to the invention and a known method using sample number 725;

FIG. 3 shows two graphs representing the average jitter J_{avg} (in %) as a function of the number of DOW cycles in a neighboring track for both a method according to the invention and a known method using sample number 725;

FIG. 4 shows a graph representing the average jitter J_{avg} (in %) as a function of the fraction P/P_{wo} of the optimal write power P_{wo} for both a method according to the invention and a known method using sample number 725;

FIG. 5 shows two graphs 51 (sample 725) and 53 (sample 828) representing the average jitter J_{avg} (in %) as a function of the pulse time Tₘₚ at a recording velocity of 6.98 m/s (2-speed) using a reference clock cycle T_{w} of 19.1 ns compared to the average level of jitter of a known method using normal pulses in a n/2 write strategy (horizontal dotted lines 52 and 54);

FIG. 6 shows two graphs 61 and 62 representing the modulation depth M of written marks during read-out as a function of the recording velocity vᵣ during writing, for a recording disk sample 210, using a short pulse write strategy (graph 61) compared to the modulation for a standard strategy (graph 62).

FIG. 7 shows two graphs 71 and 72 representing the average jitter J_{avg} (in %) as a function of the recording velocity Vᵣ, for recording disk sample 210, using a short pulse write strategy (graph 71) compared to the average jitter for a standard strategy (graph 72).

FIG. 8 shows a schematic cross-sectional view of an optical storage medium used for performing the method of the invention.

FIG. 9 shows a graph representing the laser power P (in mW) of a semiconductor laser, type MCC ML120G8-22, as a function of the pulsed current Iₚᵤₗₛₑ (in mA) to the laser. This laser was used to perform the experiments presented in the FIGS. 2 to 7;

FIG. 10 shows a sequence of pulses representing a typical write strategy of the invention for a 6T mark at 4×DVD+RW recording speed.

In FIG. 1 an example of a write strategy for DVD+RW and CD-RW is shown. According to DVD+RW and CD-RW standards different power levels and time durations are possible which are shown in this figure. With this strategy a mark 1, schematically drawn in top view, having a time length of 6*T_{w} is recorded in the recording layer of a storage medium, here an optical storage medium. T_{w} represents the length of one period of a reference clock. The 6*T_{w} mark 1 is being written by a sequence of pulses comprising a first pulse 2 followed by 4 multi-pulses 3. According to the invention the multi-pulses 3 have a pulse duration Tₘₚ<4 ns, while T_{w}<40 ns and the first pulse 2 has a pulse duration T_{first}≧Tₘₚ.

The following figures relate to recordings in an experimental optical recording medium sample nr. 725 (FIGS. 2-4), 828 (FIG. 5) and 210 (FIG. 8) having a phase-change type recording layer. These media are all substantially of the design as described in the description of FIG. 8. The recordings are performed with the semiconductor laser mentioned in the description of FIG. 9. In the following figures all short pulse (SP) strategies according to the invention are so-called n−1 strategies. All the n/2 strategies mentioned are normal “long” pulse (10 ns) write strategies. However, the invention may also be applied in n/2 strategies.

The n−1 and n/2 strategies are chosen to compare short (3 ns) and long (10 ns) write pulses. For high speed DVD+RW (>6×) probably a n/2 strategy with short pulses is required, so it is not the number of pulses of the write strategy which is essential, but rather the pulse length (Tₘₚ).

In FIG. 2, the average jitter J_{avg} (in %) is plotted (graph 21) using a known n/2 pulse strategy as a function of the number of direct overwrite (DOW) cycles. In graph 22 this relation is shown for a short pulse n−1 strategy using a pulse duration of 2.7 ns at a reference clock period time T_{w} of 19.2 ns, both parameters according to the invention. The recording velocity is 6.98 m/s (2-speed). The used medium is sample 725. It can be noted that the number of DOW cycles until an average jitter level of 15 ns is reached is increased substantially, i.e. from about 3,000 to about 10,000, when using the short pulse strategy according to the invention.

In FIG. 3 the thermal cross-talk behavior is compared (graphs 31 and 32) as a function of the number of DOW cycles for both the short pulse strategy (graph 32) and the normal pulse strategy (graph 31). Strategy parameters are the same as those used in graphs 21 and 22 of FIG. 2. The used medium is sample 725. The thermal cross talk is the influence of DOW cycles in track x+1 on the size of recorded marks of track x, which are read out as a function of the number of DOW cycles in track x+1. When the size of marks in track x are influenced by the DOW cycles in track x+1 the jitter level of the marks of track x will increase. Usually the size of marks will decrease due to backgrowth (recrystallization) of marks at the edges. Backgrowth is recrystallization of the amorphous mark starting from the edge of such mark due to a too long temperature elevation of the phase-change material. In FIG. 3 it is very noticeable that at the very first DOW cycles a slight increase in measured jitter J_{avg} (in %) in the marks of track x occurs which is equal for both strategies. But after these first cycles the J_{avg} using the normal pulse strategy continues increasing (graph 31) while J_{avg} using the short pulse strategy according to the invention remains constant and at a low level (graph 32).

In FIG. 4 graphs 41 and 42 show J_{avg} (in %) as a function of the fraction of the optimal write power (P_{w}/P_{wo}) for respectively the known pulse strategy and the short pulse strategy according to the invention. Strategy parameters are the same as those used in graphs 21 and 22 of FIG. 2. The used medium is sample 725. It can be noticed that the margin for deviating from the optimal power is much larger for the short pulse strategy according to the invention. This makes the writing process far less critically dependent on the write power of the laser.

In FIG. 5 the influence of the pulse time Tₘₚ on J_{avg} (in %) is shown for sample 725 (graph 51) and sample 828 (graph 53). It can be noticed that for sample 725 the jitter level tends to decrease when reducing the pulse duration. For sample 828 the jitter level is extremely low but tends to increase slightly when going to lower pulse duration. This increase is due to the extremely high re-crystallization speed of the phase-change recording material of this sample. Also, for both samples 725 (graph 52) and 828 (graph 54), the average jitter level of recording using a n/2 strategy is indicated by dotted lines. It should be emphasized that the jitter levels using the n/2 strategy show a substantial increase after a large number of DOW cycles as shown in FIG. 3.

In FIG. 6 the influence of the recording velocity V, on modulation depth M of written marks during read-out is shown for a high speed DVD recording disk (sample 210) with two different write strategies: The “standard” DVD+RW n−1 strategy with a long pulse length (graph 62) and a high power Short Pulse (SP) n−1 strategy (graph 61) according to the invention. DVD+RW is the abbreviation for a recently introduced format for so-called Digital Versatile (or Video) Disk ReWritable. The modulation depth M is defined as |R_{w}-Rᵤ|/Rₘ where R_{w} represents the intensity of a reflected focused radiation beam from a written mark, Rᵤ represents the intensity of this reflected focused radiation beam where no marks are written and Rₘₐₓ is the maximum of either R_{w} or Rᵤ. Usually Rᵤ is larger than R_{w}. The longer pulses (graph 62) result in a poor modulation level M because of backgrowth of the marks. The high power SP strategy (graph 61) results in a recording velocity independent high modulation level up to a recording speed of more than 14 m/s (DVD+RW>4-speed, CD-RW>12 speed). The M value of 0.60, which is considered a minimum acceptable value, is indicated by a horizontal dotted line.

In FIG. 7 the influence of the recording velocity (vᵣ) on J_{avg} (in %) is shown for high speed DVD recording disk (sample 210) with two different write strategies: the “standard” DVD+RW n−1 strategy with a long pulse length (graph 72) and the high power Short Pulse (SP) n−1 strategy (graph 71) of this invention. The longer pulse strategy results in relatively high levels of J_{avg} while the high power SP strategy results in levels of J_{avg} below 9% up to a recording speed of more than 14 m/s (DVD+RW>4-speed, CD-RW>12 speed). The 9% level, which is considered a good value, is indicated by a horizontal dotted line. Ultra high recording speeds are possible when more powerful lasers are used allowing higher peak powers in short pulses or when more sensitive recording materials become available.

In FIG. 8 the structure of the experimental media 725 (FIGS. 2-4), 828 (FIG. 5) and 210 (FIGS. 6 and 7) is shown. The phase change materials used in the described examples are of the stoichiometric Sb₂Te type doped with In and Ge. The layer structure is as follows:
0.6 mm substrate 81 of polycarbonate (PC)
80 nm of a dielectric layer 82 made of (ZnS)₈₀(SiO₂)₂₀
13 nm of a phase change layer 83 with a composition GeₐIn_{b}Sb_{c}Te_{d} and:
   0 at %<a<7 at %
   0 at %<b<10at %
   60 at %<c<75 at %
   20at %<d<30at %
25 nm of a dielectric layer 84 made of (ZnS)₈₀(SiO₂)₂₀
150 nm reflective layer 85 of Ag
0.6 mm substrate 81 of polycarbonate (PC).
   The layers were deposited using sputtering. The phase-change recording layers have a relatively high recrystallization speed.

In FIG. 9 three graphs 91, 92, and 93 are shown of the optical laser power out of a Mitsubishi type ML120G8-22 semiconductor laser as a function of the pulsed current Iₚᵤₗₛₑ. The wavelength of the laser-light is 658 nm. In graph 91 the duty cycle (DC) of the pulse is 50%. At about 85% of 240 mA the laser saturates and optical output power drops. When using a duty cycle of 37.5% saturation occurs at a level of 90% of 240 mA. With a duty cycle of 25% no saturation occurs and maximum laser output power is achieved of 32.5 mW. It is believed that the lifetime potential of the semiconductor laser is increased when using low, e.g. <⅓, duty cycles.

In FIG. 10 an example is given of a write strategy according to the invention for a 4×DVD+RW recording mode for writing a 6*T_{w} mark. The multi-pulse length (Tmp) in this example is 3.2 ns. The first pulse 102 also has a pulse width of 3.2 ns. The 4 multi-pulses 103 have a pulse height P_{w}, and an additional pulse B, denoted by reference numeral 104, has a pulse height smaller than P_{w} but higher than P_{e. P}ₑ is a constant erase power level Pₑ of the laser beam. The additional pulse B at the end of the sequence of pulses is present for controlling crystalline backgrowth. The pulse duration of pulse B is 3.2 ns and the relative power level P/P_{w} is 0.33.

It should be noted that the above described embodiments illustrate rather than limit the invention, and that those skilled in the art will be able to design alternatives without departing from the scope of the appended claims. The layer thicknesses and layer compositions of the media used for carrying out the invention may vary without departing from the scope of the invention. It is especially noted that the invention is not limited to the use with write strategies employing n−1 or n/2 pulses. Further, as described earlier, the invention is also particular advantageous when applied in ultra high speed recording systems.

1. A method of recording marks having a time length of n*T_{w}, n representing an integer larger than 1 and T_{w} representing the length of one period of a reference clock, in a storage medium, said storage medium comprising a recording layer having a phase reversible material changeable between a crystalline phase and an amorphous phase, by irradiating the recording layer with a pulsed radiation beam, each mark being written by a sequence of pulses comprising a first pulse followed by m multi-pulses, m representing an integer larger than or equal to 1 and lower than or equal to n−1,
characterized in that the multi-pulses have a pulse duration Tₘₚ<4 ns, while T_{w}<40 ns and that the first pulse has a pulse duration T_{first}≧Tₘₚ.

2. A method as claimed in claim 1, wherein T_{first}=Tₘₚ.

3. A method as claimed in claim 1 or 2, wherein Tₘₚ/T_{w}<0.30.

4. A method as claimed in claim 3, wherein Tₘₚ/T_{w}<0.15.

5. A method as claimed in claim 4, wherein Tₘₚ/T_{w}<0.075.

6. A method as claimed in any one of claims 1-5, wherein m has the value n−2.

7. A method as claimed in any one of claims 1-6, wherein the power of at least one pulse in the sequence of pulses is set in dependence of T_{w}.

8. A method as claimed in any one of claims 1-6, wherein the duration of at least one pulse in the sequence of pulses is set in dependence of T_{w}.

9. A method as claimed in claim 1, wherein the multi-pulses have a pulse height P_{w}, and an additional pulse is present which has a pulse height smaller than P_{w} but higher than Pₑ, and Pₑ being a constant erase level of the radiation beam.

10. A recording device for recording marks having a time length of n*T_{w}, n representing an integer larger than 1 and T_{w}, representing the length of one period of a reference clock, in a storage medium, said storage medium comprising a recording layer having a phase reversible material changeable between a crystal phase and an amorphous phase, by irradiating the recording layer with a pulsed radiation beam, each mark being written by a sequence comprising a first pulse followed by m multi-pulses, m representing an integer larger than or equal to 1 and lower than or equal to n−1, characterized in that the recording device comprises means for carrying out anyone of the methods according to any one of the preceding claims.
